(19) United States
(12) Patent Application Publication
(10) Pub. No.: US 2022/0230655 A1
(43) Pub. Date: Jul. 21, 2022

(54) METHOD AND DEVICE FOR DETECTING CHARACTERISTIC FREQUENCIES WITH A SENSOR

(71) Applicant: Continental Automotive Systems Inc., Auburn Hills, MI (US)

(72) Inventor: Ulrich Peter Stählin, Eschborn (DE)

(73) Assignee: Continental Automotive Systems Inc., Auburn Hills, MI (US)

(21) Appl. No.: 17/149,893

(22) Filed: Jan. 15, 2021

(51) Int. Cl. G10L 25/51; G10L 25/06; G10K 13/00; G01S 15/931; G01S 15/08; B60Q 9/00; G08G 1/16

(52) U.S. Cl. CPC G10L 25/51; G10L 25/06; G10K 13/00; G01S 15/931; G01S 2015/932; B60Q 9/008; G08G 1/162; G08G 1/166; G01S 2015/938; G01S 15/08

(57) ABSTRACT

A method of detecting a signal with a sensor. The method includes obtaining a plurality of signals with a sensor. A correlation is performed to determine if any of the plurality of signals correlate to at least one predefined signal. The at least one predefined signal corresponds to identifying the occurrence of a specific event.

### BACKGROUND

The present disclosure relates to the use of sensors, such as ultrasonic sensors, to detect characteristic sounds.

Ultrasonic sensors have been used on vehicles to assist with parking. In particular, the ultrasonic sensors are used in connection with a controller for measuring a distance from the vehicle to an object adjacent the vehicle and within the field of view of the sensor. With information from the sensors, the controller is able warn a user of the vehicle if the object is within a predetermined distance from the vehicle and provide a warning to the user to prevent a collision. These sensors generally operate in the range of 40-50 kHz, which exceeds the frequencies that a human ear can detect.

### SUMMARY

In one exemplary embodiment, a method of detecting a signal with a sensor. The method includes obtaining a plurality of signals with a sensor. A correlation is performed to determine if any of the plurality of signals correlate to at least one predefined signal. The at least one predefined signal corresponds to identifying the occurrence of a specific event.

In a further embodiment of any of the above, the signal is at a frequency at or below 16 kHz.

In a further embodiment of any of the above, the sensor is an ultrasonic sensor capable of receiving frequencies in the range of 40 kHz to 50 kHz.

In a further embodiment of any of the above, the ultrasonic sensor is located in a bumper of a vehicle.

In a further embodiment of any of the above, the ultrasonic sensor is configured for determining a distance between a vehicle and an adjacent structure.

In a further embodiment of any of the above, a trigger is generated to notify a user when one of the plurality of signals correlates to the at least one predefined signal.

In a further embodiment of any of the above, the signal corresponds to at least one of a notification related event.

In a further embodiment of any of the above, the notification related event includes at least one of a siren or a horn.

In a further embodiment of any of the above, the signal corresponds to at least one human related event.

In a further embodiment of any of the above, the at least one human related event includes at least one of children playing, bouncing balls, or voices.

In a further embodiment of any of the above, the signal corresponds to at least one vehicle related event.

In a further embodiment of any of the above, the vehicle related event includes damage to the vehicle.

In a further embodiment of any of the above, the damage includes at least one of breaking glass or scratching body panels.

In another exemplary embodiment, an assembly for detecting characteristic frequencies includes at least one ultrasonic sensor. At least one controller in electrical communication with the at least one sensor and configured for obtaining a plurality of signals with a sensor. A correlation is performed to determine if any of the plurality of signals correlate to at least one predefined signal. At least one predefined signal corresponds to identifying the occurrence of a specific event.

In a further embodiment of any of the above, the at least one sensor is an ultrasonic sensor capable of receiving frequencies in the range of 40 kHz to 50 kHz.

In a further embodiment of any of the above, the ultrasonic sensor is located in a bumper of a vehicle and is configured for determining a distance between the vehicle and an adjacent structure.

In a further embodiment of any of the above, a trigger is generated to notify a user when one of the plurality of signals correlates to the at least one predefined signal.

In a further embodiment of any of the above, at least one predefined signal corresponds to at least one human related event, weather related event, vehicle related event, or notification related event.

In a further embodiment of any of the above, the at least sensor includes a plurality of sensors. The at least one controller includes a single controller in direct electrical communication through a bus line with each of the plurality of sensors.

In a further embodiment of any of the above, the at least one controller includes a main controller in electrical communication with a sub-controller. The sub-controller compares the signal with the at least one predefined signal and determines if the signal correlates with the at least one predefined signal.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example vehicle incorporating sensors.

FIG. 2 schematically illustrates the sensors in electrical communication with a controller.

FIG. 3 schematically illustrates the sensors in electrical communication with the controller through sub-controllers.

FIG. 4 illustrates the sensor receiving signals from multiple source events.

FIG. 5 illustrates a method of detecting a signal with the sensors.

### DETAILED DESCRIPTION

FIG. 1 illustrates an example vehicle 20 having multiple sensors 22, such as ultrasonic sensors capable of receiving a signal at an ultrasonic frequency or a frequency below ultrasonic, such as below 16 kHz. Additionally, this disclosure is not limited to ultrasonic sensors but could include sensors 22 that can only receive signals at or below 16 kHz. In the illustrated example, the sensors 22 are located adjacent a front bumper 24 and/or a rear bumper 26 on the vehicle 20. The sensors 22 may be part of an existing parking assist system on the vehicle for sensing a distance of an obstacle 29 from the vehicle 20.

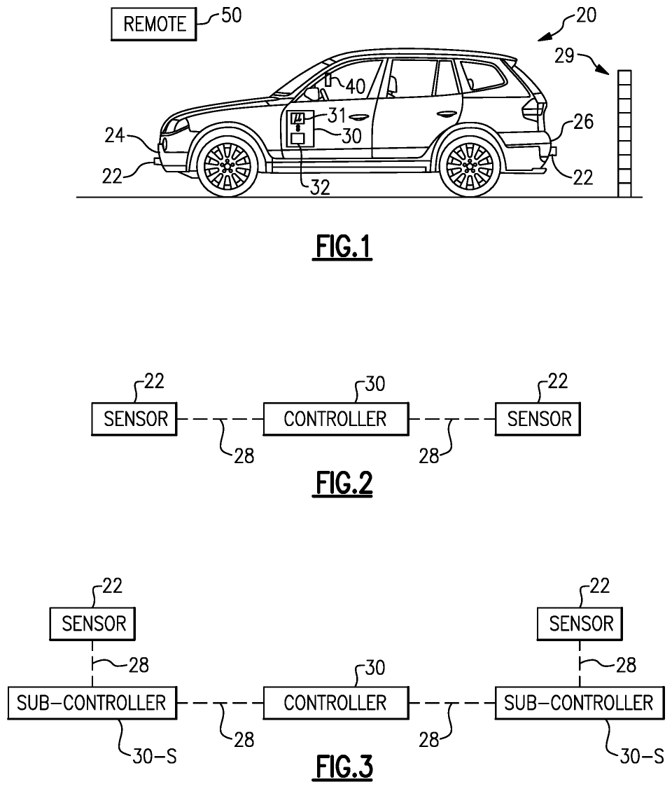

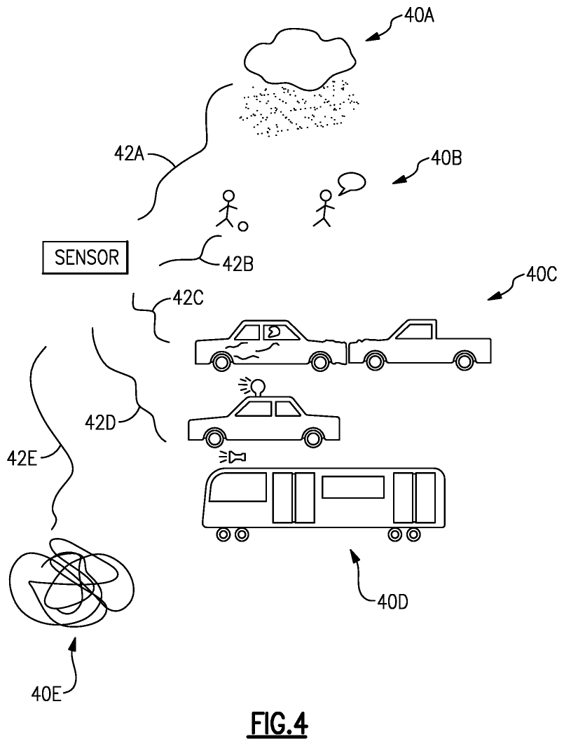

In the illustrated example, the ultrasonic sensors 22 are integrated into a surface of a front bumper 24 and a rear bumper 26 and are in electrical communication through a bus line 28 with a controller 30 having a microprocessor 31 and memory 33 (FIGS. 1 and 2). In another example, the controller 30 is a main controller located at a remote location on the vehicle 20 with a sub-controller 30-S located adjacent each sensor 22 or group of sensors 22 on the vehicle 22 (FIG. 3). The sub-controller 30-S performs the operations outlined below to reduce an amount of information needed to transfer over the bus line 28 to the controller 30. This also reduces the amount of processing needed to be performed by the controller 30 by sharing the processing load with the sub-controller 30-S.

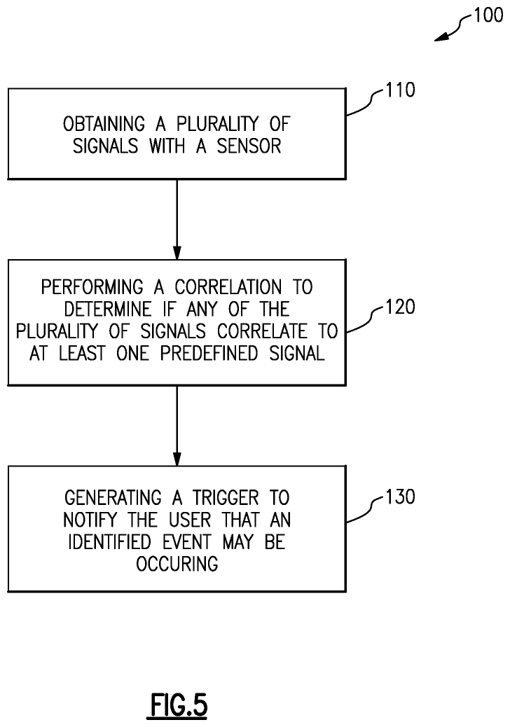

As shown in FIG. 4, the sensor 22 is capable of receiving signals 42A-42E from a number of events 40A-E. The events 40A-D generate signals from specific events that a user of the vehicle 20 may want to identify and the event 40E generates multiple signals resulting in noise that make identifying the specific events more difficult. As discussed further below, the sensors 22 and controller 30 focus on identifying the specific events 40A-D to provide further information to a user of the vehicle 20 that could be beneficial in operating, maintaining, and/or securing the vehicle 20. Although the sensors 22, controller 30, and sub-controllers 30-S are shown in connection with the vehicle 20, these elements could be used in connection with another device that could be benefit from identify these events, such as traffic related devices or public safety related devices.

In one example, the event generating the signal is from a weather related event 40A. The weather event 40A can include at least one of a rain storm, a thunder storm, a hail storm, a tornado, or another major weather event. Although each of the different weather related events 40-A emit different signals that each correspond to a different weather event, they are identified collectively as weather related signals 42A. When the weather related event 40A occurs in the vicinity of the vehicle 20, the weather related signal 42A is emitted at a frequency that is received by the sensor 22.

One feature of identifying the weather related signals 42A is for the user of the vehicle 20 to be warned about the surrounding weather climate, such as if rain or hail is approaching or currently happening. This may prompt the user of the vehicle 20 to close windows on the vehicle 20 on the account of rain or to shelter the vehicle 20 on the account of hail.

In another example, the event generating the signal is from human related events 40B, such as children playing, balls bouncing, or voices. The human related events 40B emit a signal 42B at a frequency that is received by the sensor 22. Although each of the different human related events 40B emit different signals that correspond to a different event, they are identified collectively as human related signals 42B. When the human related event 40B occurs in the vicinity of the vehicle 20, the human related signal 42B is emitted at a frequency that is received by the sensor 22.

One feature of being able to identify human signals 42B in the area surrounding the vehicle 20 is the ability to notify the user of the vehicle 20 of the possible children or pedestrians in the area of the vehicle 20. Identifying the signals 42B can also be used to signal possible vandalism of the vehicle 20 or identify a specific time that a vandalism could have happen.

In a further example, the event generating the signal is directed to vehicle related events 40C, such as a vehicle collision, breaking glass, scratching body panels, screeching tires, or air being released from a tire. Although each of the different vehicle related events 40C emit different signals that correspond to each of the different events, they are identified collectively as vehicle related signals 42C. When the vehicle related event 40C occurs in the vicinity of the vehicle 20, the vehicle related signal 42C is emitted at a frequency that is received by the sensor 22.

One feature of identifying the vehicle related signals 42C is to warn the user regarding possible damage to the vehicle 20 or the possibility of a crash in the vicinity of the vehicle 20. Additionally, this information can be used to narrow a time window of damage or theft from a vehicle to aid in recovering stolen property or catching vandals.

In one more example, the event generating the signal is from notification related events 40D, such as police sirens, fire trucks, train horns, or vehicle horns. Although each of the different notification related events 40D emit different signals that correspond to each of the different events, they are identified collectively as notification related signals 42D. When the notification related event 40D occurs in the vicinity of the vehicle 20, the notification related signal 42D is emitted at a frequency that is received by the sensor 22.

One feature of identifying the vehicle related signals 42D is to warn the user regarding the possibility of a train or emergency vehicle operating in the surrounding area of the vehicle 20. This information can be particularly helpful in the case of users with limited hearing abilities or in situations with a significant amount of background noise that could block the user from hearing the vehicle related signals 42D.

In addition to the signals identified above, there are other sources of noise 42E that can make it difficult to identify the specific signals 42A-D. As will be discussed further below, the controller 30 is able to process the signals 42A-E received by the sensor 22 and determine if any of the signals 42A-E matches the events 40A-D. and the controller 30 can then notify the user if any of the events 40A-D are likely occurring in the surrounding area the vehicle 20.

FIG. 5 illustrates a method of operating the sensor 22 with the controller 30 to detect at least one of the signals 42A-D in the presence of signal noise 42E. Once a plurality of signals 42A-E are received by the sensor 22 (Step 110), the controller 30 must process the signal 42A-E to determine if one of the above identified events 42A-D is the source of the signal 42A-D.

The controller 30 processes the plurality of signals 42A-E with many of the signals 42A-E being noise 42E unrelated to the desired events 40A-D to be identified. The controller 30 is continuously monitors the signals 42A-E by performing a mathematical correlation between the plurality of signals 42A-E reaching the sensor 22 and predefined signals (Step 120) that correspond with the signals 42A-D and the desired events to be identified (Step 120). The predefined signals include the signal produced from the events 40A-D or a representative sample of signals produced from similar events to be used in the correlation.

The correlation is a statistical analysis between the plurality of signals 42A-E and the predefined signals to identify a relationship between the signals. If the correlation reaches a predetermined threshold of accuracy or relationship between the signals, the controller 30 generates a trigger to notify the user of the vehicle 20 that the identified event may be occurring (Step 130). In one example, the predetermined threshold of relationship is greater than 80% and in another example the level is above 90%. Additionally, the controller 30 can communicate with a remote location 50 (FIG. 1) to provide information regarding the events 40A-D.

Although the different non-limiting examples are illustrated as having specific components, the examples of this disclosure are not limited to those particular combinations. It is possible to use some of the components or features from any of the non-limiting examples in combination with features or components from any of the other non-limiting examples.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claim should be studied to determine the true scope and content of this disclosure.

What is claimed is:

1. A method of detecting a signal with a sensor, the method comprising:
obtaining a plurality of signals with a sensor; and
performing a correlation to determine if any of the plurality of signals correlate to at least one predefined signal, wherein the at least one predefined signal corresponds to identifying the occurrence of a specific event.

2. The method of claim 1, wherein the signal is at a frequency at or below 16 kHz.

3. The method of claim 1, wherein the sensor is an ultrasonic sensor capable of receiving frequencies in the range of 40 kHz to 50 kHz.

4. The method of claim 3, wherein the ultrasonic sensor is located in a bumper of a vehicle.

5. The method of claim 3, wherein the ultrasonic sensor is configured for determining a distance between a vehicle and an adjacent structure.

6. The method of claim 1, including generating a trigger to notify a user when one of the plurality of signals correlates to the at least one predefined signal.

7. The method of claim 1, wherein the signal corresponds to at least one of a notification related event.

8. The method of claim 7, wherein the notification related event includes at least one of a siren or a horn.

9. The method of claim 1, wherein the signal corresponds to at least one human related event.

10. The method of claim 9, wherein the at least one human related event includes at least one of children playing, bouncing balls, or voices.

11. The method of claim 1, wherein the signal corresponds to at least one vehicle related event.

12. The method of claim 11, wherein the vehicle related event includes damage to the vehicle.

13. The method of claim 12, wherein the damage includes at least one of breaking glass or scratching body panels.

14. An assembly for detecting characteristic frequencies comprising:
at least one ultrasonic sensor; and
at least one controller in electrical communication with the at least one sensor and configured for:
obtaining a plurality of signals with a sensor; and
performing a correlation to determine if any of the plurality of signals correlate to at least one predefined signal, wherein the at least one predefined signal corresponds to identifying the occurrence of a specific event.

15. The assembly of claim 14, wherein the at least one sensor is an ultrasonic sensor capable of receiving frequencies in the range of 40 kHz to 50 kHz.

16. The assembly of claim 15, wherein the ultrasonic sensor is located in a bumper of a vehicle and is configured for determining a distance between the vehicle and an adjacent structure.

17. The assembly of claim 14, including generating a trigger to notify a user when one of the plurality of signals correlates to the at least one predefined signal.

18. The assembly of claim 17, wherein the at least one predefined signal corresponds to at least one human related event, weather related event, vehicle related event, or notification related event.

19. The assembly of claim 14, wherein the at least sensor includes a plurality of sensors and the at least one controller includes a single controller in direct electrical communication through a bus line with each of the plurality of sensors.

20. The assembly of claim 14, wherein the at least one controller includes a main controller in electrical communication with a sub-controller and the sub-controller compares the signal with the at least one predefined signal and determines if the signal correlates with the at least one predefined signal.
